(19) United States
(12) Patent Application Publication
(10) Pub. No.: US 2009/0216754 A1
(43) Pub. Date: Aug. 27, 2009

(54) System and method of distribution for geospatial data

(76) Inventors: Jeffrey Russell Ambroziak, Guilford, CT (US); Jose A. Suarez, Fairfield, CT (US)

Correspondence Address: Jeffrey R. Ambroziak, 563 Lake Drive, Guilford, CT, 06437, US

(21) Appl. No.: 12/380,297

(22) Filed: Feb. 26, 2009

Related U.S. Application Data
(60) Provisional application No. 61/067,152, filed on Feb. 26, 2008.
(60) Provisional application No. 61/134,646, filed on Jul. 11, 2008.

(51) Int. Cl. G06F 17/30

(52) U.S. Cl. 707/5; 707/E17.017

(57) ABSTRACT

In accordance with one or more embodiments, a method comprises receiving a query comprising geospatial attributes, displaying at least one image indicative of at least one geospatial data set matching the query, receiving a request for the at least one geospatial data set, and transmitting the at least geospatial data set.

The present Application claims the benefit of:
(i) U.S. Provisional Patent Application No. 61/067,152 filed Feb. 26, 2009, entitled “SYSTEM AND METHOD OF DISTRIBUTION FOR GEOSPATIAL DATA”, the entirety of which is incorporated by reference herein for all purposes; and also
(ii) U.S. Provisional Patent Application No. 61/134,646 filed Jul. 11, 2008, entitled “SYSTEM AND METHOD OF DISTRIBUTION FOR CHARGING ELECTRIC VEHICLES”, the entirety of which is incorporated by reference herein for all purposes.

### FIELD OF THE INVENTION

The invention generally relates to the storage, retrieval, and viewing of geospatial data. More specifically, the invention relates to a system and method for facilitate the viewing of geospatial data from a centralized repository.

### BRIEF DESCRIPTION OF THE DRAWINGS

FIG. 1 is a flowchart of an exemplary and non-limiting method according to some embodiments.

### DETAILED DESCRIPTION OF THE INVENTION

While Geographic Information Systems (GIS) have failed to capture a sizeable share of the market of personal computer users, the benefit of accessing geospatial data continues to increase. Stovepipe applications of geospatial technology, like Google Earth™, provide individuals access to worldwide coverage of the earth consisting of geo-referenced imagery, course digital elevation data, and various other data. One limitation of Google Earth™ is that the Google provided data must always be used as a base map when attempting to combine personal geospatial data. This is not always desirable.

Another problem when attempting to utilize geospatial data is that of data formats. Image and elevation data is typically stored in a variety of incompatible data types including, but not limited to SDTS, IMG, shape files, .DEM, geotiff, .LBL, .LBM, .DAT, etc. As a result, when a person obtains some data of interest, it is likely to be in a format that is difficult or impossible to read and utilize.

Despite these barriers, large volumes of geospatial data are being created every day by persons as diverse as scientists, students, professors, geologists, architects, sociologists, outdoors enthusiasts, etc. Unfortunately, while websites such as gisdatadepot.com provide government GIS data for sale, there exists no central place for individuals to post their geospatial data sets so that interested parties can easily find the data, download it, and use it.

Exemplary and non-limiting embodiments of the invention provide an end to end solution for the creation, distribution, and utilization of geospatial data. As described in detail in the exemplary and non-limiting embodiments below, the system comprises a server or servers on which is stored geospatial data in a standard format. Users of the system can upload datasets comprising, at a minimum, image and terrain data. Once uploaded, the datasets can be searched or otherwise accessed by users of the system and downloaded for viewing and exploration of the dataset or datasets. The software for viewing the datasets may reside on a server of the system or may be downloaded to a computer of a user. Uploading, searching and downloading datasets by a user may be accomplished via the internet by employing, for example, a web page interface.

As used herein. A “DEM” refers to a Digital Elevation Model. A DEM is an array of values corresponding to elevations arranged in a grid pattern. Also referred to as a “digital terrain model” or “terrain model”.

In accordance with exemplary and non-limiting embodiments of the invention, data sets comprising, at least, a surface texture and an associated terrain model are stored on one or more servers with a visual representation of the data. Although one or more servers can be utilized to store the data sets, one or more servers operate to provide a unitary access point to purveyors and users of the data sets. As described more fully below, data may be browsed and accessed via the internet. Subsets of the data, such as the visual representations of the data sets and other descriptive information (such as available data sets and information used to search the datasets) may be stored on a server hosting one or more web pages while the image and DEM files are stored on one or more additional servers. In this way, if a user decides to access a data set via a selection entered on a web page, the actual download will occur from a server selected by the system. For example, the data sets can be mirrored on more than one server and the system may instruct the download to commence from a server with the lowest utilization. Conversely, the user may be provided with a list of available servers from which the user selects a desired server.

In accordance with exemplary and non-limiting embodiments of the invention, the surface texture is a georeferenced image depicting a terrain surface. Examples include, but are not limited to, aerial photographs, satellite images, maps (comprising both vector and raster data), etc.

In accordance with exemplary and non-limiting embodiments of the invention, the Terrain model is a DEM.

Both the image and DEM are stored as comprised of one or more subfiles wherein each DEM subfile is comprised of an equal number of rows and columns. Each DEM subfile corresponds to an image file covering the same geographic area. In one embodiment, each DEM is a binary number of rows by a binary number of columns (e.g., 1024×1024). By dividing the data in this manner algorithms commonly utilized to interface with graphics cards are optimized. Example formats for the image and DEM include .pgm and ppm. In addition to the standard format of .pgm and .ppm files, additional data may be embedded in the files for use by the system. One example of embedded data might comprise a value formed from a hash of the image and/or DEM data. When a user attempts to view a data set with such embedded information, the hash is retrieved by the viewing software application and sent to the system, a comparison is performed. If the hash value does not match the stored hash value maintained by the system, use of the data set by the user is prevented. In this manner, the user must maintain a connection to the server in order to view a downloaded data set.

In one exemplary embodiment, all downloads are free. Once downloaded, data sets may be sent or given to others via any desired means. However, to view the data sets using the viewing software, a connection must be maintained between the user and the system, such as via the internet, in order to view the data sets as described above.

In one exemplary embodiment, a data set may be purchased for a nominal sum. By so doing, a hash is created using data from the data set and an attribute of the user/purchaser (such as a registration code of the viewing software), with the resulting hash embedded in the data set. As a result, when the user attempts to view the data set, the hash is recomputed locally on the users machine, such as by the viewing software, and viewing is enabled without a connection to the system.

The visual representation is a video depicting, at least, the image and DEM data. For example, the visual representation may be an mpeg video of a fly-through of the data set. When made available to a user via the internet, a still shot from the mpeg can be displayed on a web page with accompanying additional data, such as text data.

In one embodiment, the snapshot serves as a hyper link to the mpeg video. When a user clicks on the snapshot from a web browser, the mpeg video plays. Watching the mpeg video provides a feel for the resolution of the image and DEM data as well as the geographic extent of the data set.

Additional data for use with the image and DEM data may include point, line, area, and audio data, and other geospatial models and textures. For example, a 3D model of a building, temple, or other physical structure may be included for download. A snapshot or a flythrough of the model may be included to aid in making a decision whether or not to download the model. In addition, a reduced resolution model may be displayed and manipulated, as through a flash interface.

For example, image and DEM data for a portion of New York City are downloaded. Likewise, a snapshot of a high resolution model of the temple of Dendur at the Metropolitan Museum of Art is displayed. Once downloaded, the model of the temple can be displayed. In one embodiment, the temple model is displayed with the DEM and image data in seamless fashion. In another embodiment, an icon is displayed with the DEM and image data indicating that a model exists at a defined point or area. For example, a sphere is positioned at the position of the museum. Clicking on or otherwise selecting the sphere displays information about the temple model and/or opens the model for viewing. Such viewing may utilize system software or may invoke third party viewing software, such as 3D Studio Max™.

In another example, a model may be available of the outdoor intersection of 51^{st} street and fifth avenue. A sphere may be displayed with a radius of a size sufficient to bound or encompass the model data. In addition to the model, audio data may be associated with the model or individual points in the model. As a result, as one moves around the model street sounds are played to enhance the realism of the experience.

In one exemplary embodiment, the system computes a shaded relief image from the terrain model (possibly color coded by elevation), applies political boundary data (optional) and optional place names and displays the derived image to give a user a sense of geographic context of the data set.

In addition to the data available for download, additional information may be stored for use by the system to, for example, facilitate searching of the data sets. Examples of such additional data include, but are not limited to, geographic extents of a data set, key words, a unique identifier for the data set, a record of other data sets that are congruent with a data set.

For example, a data set corresponding, at least in part, to a 1:24,000 quadrangle of New Orleans may be assigned a unique identifier of “2909007ne” and may be comprised of an image and a DEM such as 2909007ne.ppm and 2909007ne.pgm, respectively. Each of 2909007ne.pgm and 2909007ne.ppm are individual tiles that may be seamlessly combined with another data set, for example, “2909007se”. As a result, a user can download a file of interest, such as 2909007ne, that is of a desired size and expanse. When selecting the data set for download, an indication, such as a displayed map, may show the user other data sets available for download that are adjacent to the desired file so that the user may choose to additionally download the other indicated files such as, for example, 2909007se.

In one exemplary embodiment, data may be embedded in a data set that indicates that it is a replacement for an individual tile in another data set. For example, a first data set, 2902007se, may be comprised of a 4×4 matrix of .pgm and ppm files. A second data, 29092007se_afterflood, set may be identical to the first data set with the exception of the tile at row 2, column 2 that depicts flood damage. In such an instance, the second data set need only be comprised of the substitute tile. When a user downloads the second data set, a check is performed, or an option is extended to the user, to download 2902007se and the substitute tile of 29092007se_afterflood or, if 2902007se is resident on the user's computer, just 29092007se_afterflood. In this manner duplicative information is not downloaded from, or stored upon, the system server. In a similar manner, it is more likely that data sets comprised of different images will be packaged with the same DEM. In such an instance, only the image information is downloaded if the user already has the appropriate DEM from another download.

In another example, a user may search for “Yosemite” and one or more data sets that have the keyword “Yosemite” associated with them are displayed, such as via an mpeg snapshot. In addition to stored keywords, the system may operate to derive keywords and other indicia of the data sets upon which to search. For example, based upon latitudinal and longitudinal expanse of a data set of Yosemite national park, the system may operate to generate one or more parameters indicative of the data set, such as “California” and “U.S”. Other keywords associated with a data set may be generally descriptive such as “canyon”, “coastal”, “mountainous”, etc.

Additional data may further include an identifier of the creator and poster of a data set, such as an Email address. If the creator of a data set gives permission, individuals downloading or browsing the data set can contact the creator. Such permission can take several forms. On one end of a spectrum, the creator's Email, is made available to any user of the system. On the other end of the spectrum, no one can obtain an identifier of the creator of a data set. In between, a creator may allow Emails to be forwarded to him, via the system, without the sender knowing the identifier.

As described more fully below, communities, comprising users with interest in similar data sets, may be established and maintained. In this way, users, such as hikers, professors, etc. with a specific interest in a particular area can establish and maintain correspondence regarding the data sets.

In addition to an identifier of the creator of the dataset, images and text affecting a branding of the dataset may be uploaded for display to users of the system and the datasets. In this manner, organizations and individuals can obtain recognition for the quality of their datasets.

Stored data corresponding to data sets can be used to direct advertising to users. For example, users accessing data related to Yosemite national park may be provided with web links to outfitters in the Yosemite area.

In an exemplary and non-limiting embodiment, users access a web page (such as www.vou-vista.com) to search for data sets, to download desired data sets, to post data sets, and to interface with the system, as well as with other users via the system, as described herein.

Data sets may be created using, for example, CartaVista™ by A3Dt, Inc. In one embodiment, at a minimum, each data set includes an image and a corresponding DEM in a standard format. An example of standard formats are the .pgm and ppm formats described above. Advantages of so doing include optimized integration with graphics cards. More specifically, square DEMs (particularly those having binary dimensions) are optimal for implementing quad trees to optimize the number of triangles that must be plotted to produce a single perspective image of the image and terrain using, for example OGL.

Using software, such as CartaVista™, datasets for use with the system can be created and uploaded. For example, CartaVista™ allows a wide variety disparate GIS data formats to be inputted and seamlessly combined regardless of scale, projection, etc. CartaVista™ further enables outputting data in the standard formats established for download via the system. Data sets so created may be uploaded to a data server forming a part of or in communication with the system via CartaVista™ operating as a stand alone executable on a PC (such as via an FTP transfer) or through, for example, a web based interface such as a web page hosted by the system. Checks of the data to ensure their integrity and compatibility with the system can be performed on a client machine, such as a PC running CartaVista™, prior to uploading. Conversely, the system may perform checks to make sure that the data is free from corruption at any time from the receipt of the uploaded dataset to the time at which the dataset becomes available to users.

CartaVista™ can also be utilized to create sample fly-throughs or other visual representations of the dataset such as perspective snapshots.

In one embodiment, the system produces a visual representation such as a snapshot or fly-through of the dataset. For example, the system may produce a default movie comprising the terrain and image data rotating beneath a fixed point. Alternatively, the system may compute a perspective rendering from a default point or one selected by a user of the system.

In addition to the required image, terrain, and visual representation data, other geospatial data associated with a dataset may be uploaded and accessed by other users.

Examples of static data include point and line data comprised, in part of textual data. Such data might contain points of interest or trail paths.

In addition, dynamic data can uploaded and made available. For example a dataset may be dynamically uploaded with location information of individuals. For example, the system may be configured to store, such as in a relational database, location information of individuals captured by a mobile device, such as an iphone, a mobile telephone with GPS capability, a blackberry, and the like. In such an instance, the individuals permitted to view such data may be password protected. Users of the system can download an appropriate dataset, such as of a city or Yosemite National Park and also access point data of family members and fellow hikers for display with the dataset.

In addition, users viewing a dataset may be enabled to query additional data in such dynamic datasets to which the individual has access. For example, users may download a dataset of New Orleans and query to see what data sets encompassing, in whole or in part, the extent of the dataset are available. Continuing with the example, a dataset of point data indicating the location of red cross emergency personnel may be indicated as being available to all users. The user may access this data and overlay it on the New Orleans dataset. The downloaded data may additionally include an object file (such as a .obj) or a bit map associated with the point data. For example, a red cross may be plotted at each point location overlayed on the dataset or the bitmap may be displayed, such as on a floating billboard. Standard symbols may be defined by the system for fire, police, rescue and the like.

In one embodiment, hot links may be displayed so that a user in communication with the system and viewing a dataset may instantly access police, fire, and rescue personnel location information.

In an embodiment, location data may be restricted based upon a security access code associated with a user session. For example, in the preceding example, the location of military personnel may not be available to most users of the system but may be made available to users with a registration id that indicates an appropriate security clearance.

In one embodiment, the upload of data may be dynamic and enabled by a user of the system. For example, a person may execute an application on an iphone (or a vifone or the like) to upload the person's location every five minutes on a server or other database associated with the system. The person may define one or more users of the system permitted to view this information. In the instance that the person chooses not to execute the location application, a user of the system, who has permission to view the person's location may issue a query, via the system, to activate the executable on the person's iphone. An indication that the person's location is now being viewed by an allowed person may be displayed on the iphone. In such an instance, the person may have displayed an option to upload his location or not. The response to the option may be kept secret so that the user seeking to gain location information does not know if the person was unavailable or declined to allow access.

In all instances, the system may enable communication amongst persons in communication with the system. For example, a user may be viewing a portion of New Orleans with spheres plotted at points corresponding to rescue personnel. Touching on a sphere causes textual information related to the point, such as a phone number, to be displayed. Touching on the displayed phone number causes a phone call to be placed, such as by Skype™ to the person associated with the sphere and point data. In addition to voice communication, text and video data, for example, may likewise be exchanged.

In one embodiment, the system or a person using the system may request location information of a person operating a mobile platform in communication with the system. Such a request may take the form of a text message sent to the iPhone of a person. In addition to containing information sufficient to request location information (such as data instructing a location executable to execute on the person's mobile platform), the message may contain additional information. For example, the message may contain information telling the mobile platform where (server id, IP address, SQL server info, etc.) to send the requested location information. Additional information includes an instruction to take a photo with the iPhone as well as an email address where the photo is to be sent.

For example, a user of the system is viewing a dataset of New Orleans with dynamic point data showing persons in distress. In addition, there is displayed dynamic point data corresponding to rescue volunteers dispersed about New Orleans. By touching (if the viewing software is displayed on a touch screen) or clicking on a displayed point corresponding to a rescue volunteer, attribute information associated with the volunteer is displayed, including the phone number of the volunteer. By touching or otherwise selecting the phone number, the computer on which the visualization software is running places a call, such as via Skype, to the volunteer. In addition, a text message can be sent to the volunteer's phone requesting a photo be taken of the surrounding environment and sent to an email account managed by the system or other account.

In an exemplary embodiment, a user accesses information regarding available data sets via the internet in web page format. The web page may display snapshots (each a hyperlink to additional data, including a download link) from mpegs of fly-throughs of one or more data sets. For example, the home page of the system may show the top five most downloaded datasets in the form of snapshots. Alternatively, the system might show one or more snapshots associated with data sets (perhaps newly added) that may be of interest to the user, based upon, for example past downloads of the user or on stored preferences of the user.

In one embodiment, the user searches using keywords.

In one embodiment, Suggestions of data sets are presented to the user. For example, the home web page of youvista.com may have a section, such as “MyVista”, where there are presented selections of data sets. The selection may be based upon a search of data sets resident in the system with a geographic expanse that is at least partially coincident with the geographic expanse of other datasets that the user has downloaded or in which the user has expressed an interest.

In one embodiment, the user searches by clicking on a dynamic map that visually displays selectable geographic areas. Once an area is selected, data sets that cover an area in proximity to the selected area are displayed for download.

Once a hyperlink is selected by a user, additional information associated with the selected data set is displayed. For example, an Email address associated with the creator of the data set may be presented. Ratings of the data set by other users may be presented. Textual descriptors of the data set may be stored by the creator and displayed. For example, there might be displayed “Yosemite aerial photography of half-dome (24 bit color, 1 m resolution) overlayed on DEM created from USGS 1:24,000 DLG. Yosemite Falls region also available as separate download.”

The user is provided with links to the image and terrain data to enable downloading. The links may be individual or a single link may download the matching image and DEM data. Other data comprising the data set may be stored by the creator. For example, point, line, area, and audio data may be stored for download by the user. For example, points representing spots of interest or a line created by a GPS device recording a preferred trail hike may be offered for download. The points and lines may be attributed with additional information (other than latitude and longitude information) such as text information. In addition, a configuration file may be included that specifies how the point, line, area, and audio data is to be displayed and/or presented. For example, points representing trail outfitters may appear as a preferred icon overlayed on the image and terrain data (as specified in the configuration file). When the user nears a point so displayed, in a virtual manner, via the visual interface, the name of the outfitter and an internet link may appear. By clicking on the link, if the user is internet enabled, the website may be presented. Likewise, an audio file of running water may be specified to play when the user is near a river (defined in a downloadable line or area file) in the virtual environment (as specified in the configuration file).

Once downloaded, the visualization software allows a user to modify the configuration file, such as, for example, to turn off the playing of audio files or to change the font in which textual information is displayed.

In addition to data sets, users may download visualization software from the system, such as via a web page. In one embodiment, the downloaded visualization software is free. In some embodiments, the software must be registered and a registration id provided from the system and stored on the user machine running the software. As described above, in such an instance, some aspects of a users activities can be controlled by the system. In some instances, this control is required to produce advertising revenue to support the creation and maintenance of the system.

In addition to viewing the data, the visualization software can enable measurement and analysis of the dataset. For example, while viewing a fly-over of the dataset, a user can touch two points in the perspective rendering and the visualization software determines the latitude and longitude of the two points, computes a distance between the points and displays the distance to the user. Likewise, a shortest path can be computed between the points and a 3D line computed and displayed within the perspective rendering.

In one embodiment, a dedicated web address or other accessible address may be provided to any user in need of emergency response data. Presently, dialing 911 anywhere in the U.S. routes a call to police and fire personnel. Similarly, executing an application, such as on an iPhone, would immediately route the user of the application to a repository of applicable information.

For example, a hurricane survivor enables a dedicated application. Data is downloaded for viewing, as described herein, allowing the user to fly over and around his surroundings in a virtual manner. Pressing on the icon for emergency services, causes icons representing red cross stations to be displayed on the iPhone. Pressing on one such icon causes the display of an RFID updated list of the inventory at that red cross station. Pressing another button passes the users GPS determined present location to a Google earth™ application on the iphone and displays directions to the red cross station.

Access to certain data may be limited based upon location to guarantee access by the most needy individuals. For example, weather and other data may be made available (or the user may be granted priority) for viewing to a user only if the user is within a predefined emergency area.

In one embodiment, visualization software may be resident upon a mobile platform, such as an iphone or the n vifone by Garmin International Inc., a unit of Garmin Ltd. (Nasdaq: GRMN).

In such an embodiment, the perspective renderings of the fly-throughs of a data set may be computed by the system, compressed (such as into mpeg video), sent to the iphone and displayed. Control icons can be displayed and utilized on the iphone with the control information sent to the system so as to control the flight path and other fly-through parameters.

In one embodiment, the orientation of the mobile platform may be utilized to control visualizations. For example, accelerometers and the like within an iPhone used to determine the orientation and motion of the iphone. This information can be used to control the visualization of geospatial data such as by controlling flight parameters associated with a fly-through e.g., tilting forward produces forward movement, tilting to the right produces a turning motion to the right, etc.

In another embodiment, a dedicated client computer, such as the user's computer running visualization software (described above), can communicate with an iphone, such as via wi-fi, Bluetooth, or phone link, to provide snapshots (such as jpegs) of a fly-through controlled by the user. When data throughput is sufficient, these snapshots form a real time, or near real time, visualization experience.

In one embodiment, the system may be configured to keep a specific data set resident in memory so as provide multiple users with near real time data streams as described above. In another embodiment, a user's computers may be set up as a server. For example, a user may load a data set of Yosemite park on a home computer and establish communication between an iPhone and the home computer. As long as the home computer remains on and in communication with the iPhone, the user can use the processing power of the home computer to generate images which are sent to the iPhone.

One advantage of the above embodiments is that mobile platforms lacking sufficient processing and graphics capabilities to make full use of the system can work in partnership with the system or another computer by offloading the computationally intense activities to another computer. In one embodiment, a hybrid architecture is envisioned whereby a subset of a dataset is utilized on an iPhone for manipulation with a full rendering being computed on another computer and sent to the iPhone when requested. For example, the points forming a wire frame model of New York City are downloaded to an iPhone along with point data specifying the location of the temple model. The iPhone is capable of rendering the wireframe and point data. When requested, the parameters of view angle, height, etc. are sent from the iPhone to another computer running system software and a full resolution image matching the sent parameters is generated and sent to the iPhone for display. Such an approach maximizes the processing capabilities of each platform and minimizes communication and data traffic between platforms.

In one embodiment, the system, at least one client, and at least one mobile device may be in communication with one another. The client may be, for example, a pc or pc compatible device running visualization software. The mobile device may be a cell phone, such as an iPhone. The system, the at least one client, and at least one mobile device form a mobile device architecture. As described more fully below, whether via direct bidirectional communication or via the system, the client and the mobile device may exchange data.

In an exemplary embodiment, an application executable on the mobile device determines a location of the mobile device and sends the location information to the client. For example, an iPhone application determines location information, such as a longitude, a latitude, and a confidence level radius. The location information may be sent directly to a client via a communication protocol such as, for example, Hypertext transfer protocol (HTTP) or Short message service (SMS) protocol. By “directly” it is meant that the communication of location information between the client and the mobile device does not involve storage or transfer of location information via the server component of the system. Alternatively, the location information may be sent to the server portion of the system for access by other clients and mobile platforms.

Client to mobile device communication. For example, an iPhone determines location information and sends the information via a communication protocol to an ftp address to which the client has access. The ftp address may be stored on the iPhone and accessible to a location application operable on the iPhone. Conversely, the application may be activated, such as by the receipt of a message (such as an SMS message) via a communication from the client in which is embedded the address and password of the ftp site where the location information is to be stored. In this manner, access to the location information is limited to clients with access to the ftp site. The location information, as well as messages used to invoke the execution of the application, may be further protected through any known encryption method. Once stored, a client, using visualization software, can overlay the location information on a viewable dataset using the system. For example, a long running application on a client platform may periodically check to see if additional location information has been received from a mobile platform and stored for retrieval by the client. The check may be performed on a site accessible to the client, such as an ftp site. Conversely, an application resident on a platform in communication with a server hosting the location data may affirmatively alert clients of updated location information.

Reformatting of the data to enable visualization with the visualization software may be performed by the client or by an application resident on a server hosting the location data.

In another example, the communication between the mobile platform and the client does not require an external server. For example, the mobile device may communicate the location information via a SMS message. In another example, the client device may be set up with a unique address to enable http communication between the mobile device and the client.

Client to system communication. For example, an iPhone determines location information and sends the information via a communication protocol to the system. The system may store the location information in any desirable format to facilitate access by users of the system, for example, as a flat file capable of being downloaded or in a data server, such as an SQL server.

For example, a user may view a dataset of New Orleans during a disaster, such as hurricane Katrina. In addition to the terrain model and imagery forming a dataset, one or more color coded surfaces corresponding to radar generated images of weather phenomenon may be displayed over the terrain, perhaps at varying degrees of opacity/translucence. The user periodically downloads a point file comprising the locations of emergency workers who have previously sent location information to the system for access by users/clients. Such access may be password protected, encrypted, or otherwise restricted. This point file can be viewed using the visualization software using, for example, one or more of the methods described below.

In the above example, the location information may be augmented with additional data. For example, the location information may contain the phone number or other identifier of the mobile device. An operation, such as an SQL join or a logical equivalent, may be performed to add additional information, such as a name of the individual operating the mobile device. As a result, when the data is viewed by a user of the system, this additional information is available. Continuing with the present example, a user downloads location information of emergency workers and plots them as spheres surrounded by translucent spheres corresponding in radius to a confidence radius (such as a 95% confidence radius). When the user touches, clicks, or otherwise selects a portion of a viewing screen corresponding to one of the spheres, the visualization software determines which sphere has been selected and displays information associated with the sphere. For example, the latitude and longitude is displayed as well as the phone number and name associated with the sphere. For example, the phone number “203.535.3897” and the name “Jeff Ray” are displayed in text fields. These fields may be tied to user specified actions. For example, touching on the phone number may cause a call to be placed to the mobile platform, such as via Skype™.

Whether querying or performing a geospatial query from the system, on the client platform, or on any platform in communication with the client or the system, the location information may be formatted in response to a request and made available for viewing. For example, a user may request point data corresponding to all emergency workers within a ten mile radius of a specified point that have an attribute of being “online”. A response to the query is performed and the data forwarded to a user for visualization by the user.

It is understood that in all instances described above, the mobile device may act as a client device/user of the system.

As noted above, point, line and area data may be downloaded to be viewed with a dataset. Various conventions may be employed to display multi-dimensional data associated with a vector data component. For example, a point, displayed as a sphere, may be assigned a hue, saturation, intensity or size corresponding to an attribute. For example, a point set comprising the location of people in distress may be displayed as spheres where the saturation varies according to how old location data is. In this manner, older point data looks more washed out and accords with the human perception that it is older and less likely to be accurate.

In addition to spheres, OGL provides support for the display of numerous geometric shapes including, but not limited to, cones and tori (plural of torus). The hue, saturation, intensity, size and orientation of such shapes may be utilized to display multidimensional data. For example, each point corresponding to a person in distress may be augmented with data fields corresponding to the direction to the nearest first aid station and evacuation center. When the points are plotted as spheres, two cones extending from the sphere may be color coded (red=first aid station, blue=evacuation center) may point, perhaps parallel to the ground, to the first aid station and the evacuation center. When a user of the system touches or otherwise accesses data corresponding to a displayed sphere and facilitates communication (via telephone or other method, such as text messaging) with the corresponding mobile device represented by the sphere, the user can give directions and aid based upon the perceived orientation of the displayed cones. For example, the user may communicate, “There is an aid station north of you and an evacuation center to the north west.”

In another example, a cone may extend from a sphere plotted above the terrain and extend down to the ground. This configuration may be used to represent that the point data is “tied” to a place on the ground above which another point is plotted, for example a point representing a plane 10,000 feet above the ground. In such an instance, a sphere representing the plane may be plotted 10,000 feet above the surface or text may be plotted over the sphere from which the cone extends indicating the height of the associated point. For example the text “10,000 feet” may be plotted over the sphere. As such points are continually and repeatedly plotted, one can observe both the location of persons in need of assistance on the ground while simultaneously viewing the location of rescue planes and helicopters in the air.

In addition to geometric shapes, non-geometric shapes may be defined, such as in a .obj format, textured, and displayed. In addition, floating billboards may be employed. For example, rescue workers may be represented by a floating billboard displaying a photo of the worker for easy identification.

In an exemplary embodiment, multiple passwords may be employed to provide security on a mobile device. There may be defined a first password to enable normal operation of the aforementioned application and an alternate password. Use of the alternate password will enable operation of the mobile platform, perhaps in a protected mode, while indicating that something is wrong. For example, a mobile device receiving and transmitting location information corresponding to secured assets is forcibly taken by nefarious characters. The password to operate the mobile device may be extracted from the owner of the mobile device using unsavory techniques. Upon providing the alternate password, an application on the mobile platform immediately informs the system of the location of the compromised mobile device. This information may be displayed via visualization software to indicate the location of the compromised mobile device.

In addition to the ability of a user of the system to instruct a mobile device to execute the application for reporting location information, the user may require a predefined password to be entered in order to activate the application.

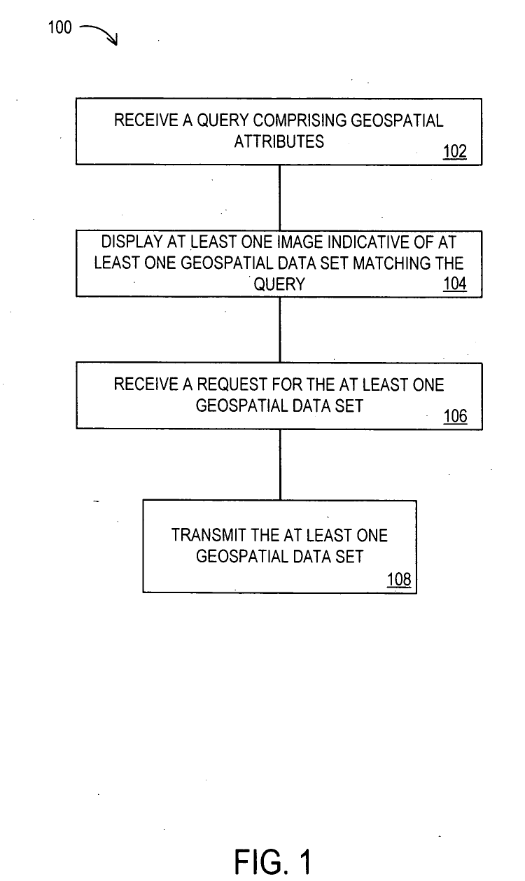

According to some embodiments described herein, a method of implementing such embodiments may comprise querying geospatial data sets based on user queries descriptive of geospatial attributes. In FIG. 1, for example, a method 100 according to some embodiments is shown. The method 100 may, according to some embodiments, comprise receiving a query comprising geospatial attributes, at 102. The method 100 may also or alternatively include displaying at least one image indicative of at least one geospatial data set matching the query, at 104. The method 100 may also or alternatively include receiving a request for the at least one geospatial data set, at 106. The method 100 may also or alternatively include transmitting the at least geospatial data set, at 108.

What is claimed is:

1. A method comprising:
receiving a query comprising geospatial attributes;
displaying at least one image indicative of at least one geospatial data set matching the query;
receiving a request for the at least one geospatial data set; and
transmitting the at least geospatial data set.
